(19) United States
(12) Patent Application Publication
(10) Pub. No.: US 2007/0211454 A1
(43) Pub. Date: Sep. 13, 2007

(54) Externally accessible and adjustable optic and adjustable base for ground-mounted lighting fixture enclosures

(76) Inventors: Jeff Shaner, Covington, GA (US); Michael Lay, Morrisville, NC (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/706,798

(22) Filed: Feb. 14, 2007

Related U.S. Application Data
(60) Provisional application No. 60/773,248, filed on Feb. 14, 2006.

(51) Int. Cl. F21S 8/00

(52) U.S. Cl. 362/153; 362/431; 362/282; 362/322

(57) ABSTRACT

Devices and methods for externally accessing and adjusting a lighting fixture optic and adjusting a lighting fixture enclosure on its base. Embodiments provide a lighting fixture enclosure with an opening at the top that both receives a removable screw for securing the top and, when the screw is removed, allows insertion of a tool to rotate a reflector and thereby adjust the rotational direction of the light. Such a reflector may be movably coupled to an inside surface of the fixture top while being secured to a bracket. A tool inserted through the opening at the top of the fixture may engage an aperture in the bracket such that as the tool is rotated, the bracket and secured reflector also rotate. Embodiments also involve a base support mounted within the bottom end of a lighting fixture enclosure and a base having apertures for receiving anchor bolts to mount the base to a surface and configured to be received within the base support such that the lighting fixture enclosure is rotationally adjustable about the base.

### RELATED APPLICATION

The present application claims the benefit of provisional patent application Ser. No. 60/773,248 filed on Feb. 14, 2006 entitled “Externally Accessible and Adjustable Optic and Adjustable Base for Ground-Mounted Lighting Fixture Enclosures,” the entirety of which is incorporated herein by this reference.

### FIELD OF THE INVENTION

This invention relates to features for outdoor ground-mounted lighting fixture enclosures, and, more particularly, to externally accessible and adjustable optics and bases for such lighting fixture enclosures.

### BACKGROUND OF THE INVENTION

Free standing lighting fixtures are mounted to the ground to emit light to illuminate walkways and other areas. Typically, such fixtures emit light in many directions but focus light in one or a few specific directions. Such lights may intentionally use asymmetric optic reflectors to selectively illuminate in certain directions more than others and, thus, will not emit light uniformly in all directions. For example, a free standing lighting fixture positioned next to a walkway may direct light primarily toward the walkway but also provide some light that illuminates surrounding bushes, signs, and other objects.

Unfortunately, existing ground-mounted lighting fixture enclosures have numerous shortcomings. For example, once installed they do not allow for easy adjustment of the light direction because they do not permit adjustment of the optic located inside the top end of the enclosure to be carried out from the outside of the enclosure. In contrast, to adjust the optic, the entire top must be removed and inverted. The optic is adjusted or rotated manually, and then the entire assembly is replaced. This is time-consuming and inefficient.

Existing free standing lighting fixtures are also mounted to the ground in ways that limit adjustment of the orientation of the fixture. The orientation of the fixture itself (in addition to the direction of the emitted light) often is important, especially where the shape of the fixture has a direction. For example, a series of fixtures each having an oval-cross section may be designed to aesthetically coordinate and complement one another when directionally aligned and positioned at discrete positions along a walkway, e.g., aligning the long axes of the oval cross section of each fixture perpendicular to the walkway. Existing enclosures are ill suited for such alignment because they do not allow for adequate rotational adjustment. In a typical base, such as the base 27 shown in FIG. 5, the fixture 25 is installed by first installing the base 27 using anchor bolts (not shown) and then positioning a base support 26, which is mounted to the fixture 25, in one of a limited number of rotational orientations (four, in this case) governed by the orientation in which base 24 was anchored to the ground. Thus, the base 24 must be installed in a precise orientation to ensure proper fixture direction. Minor errors in base orientation may destroy an intended aesthetic. Such errors can only be corrected, if at all, by the time consuming process of removing and re-anchoring the base.

Accordingly, there is a need for ground-mounted lighting fixture enclosures where the lighting fixture optic inside the enclosure may be accessed externally and its positioning adjusted as desired. Similarly, there is a need for ground-mounted lighting fixture enclosures that may be rotated on their respective bases for the purpose of aesthetically and optically aligning lighting fixtures to one another and to the surrounding architecture as desired.

### SUMMARY OF THE INVENTION

The present invention provides devices and methods for externally accessing a lighting fixture optic to adjust its rotational direction. For example, certain embodiments provide a lighting fixture enclosure with an opening at the top that both receives a removable fastening device (e.g., a screw) for securing the top and, when the fastening device is removed, allows insertion of a tool to rotate a reflector and thereby adjust the direction in which the light projects from the fixture. Such a reflector may be movably coupled to an inside surface of the fixture top. A tool inserted through the opening at the fixture top may engage a bracket secured to the reflector such that, as the tool is rotated, the bracket and reflector also rotate.

The present invention also provides devices and methods for rotating a lighting fixture enclosure on its base. Certain embodiments involve a ground-mounted base configured such that a lighting fixture may be attached to the ground-mounted base and rotated over a range of rotational orientations. For example, the base may have a circular screw contacting frame or other portion that allows set screws of a base support to secure the base over a range of rotational orientations.

### BRIEF DESCRIPTION OF THE DRAWINGS

FIG. 1 is a perspective view of a ground-mounted lighting fixture enclosure according to an embodiment of this invention, within which the optic of FIGS. 2A, 2B, and 3 and/or the base of FIG. 5 may be used.

FIGS. 2A and 2B show an exemplary embodiment of an externally accessible and adjustable optic for use in a lighting fixture enclosure according to the present invention.

FIG. 3 shows the configuration of FIGS. 2A and 2B, with the screw and gasket removed and a tool inserted to rotate the reflector of the lighting fixture.

FIGS. 4A, 4B, and 4C show an exemplary embodiment of a lighting fixture top and reflector according to the present invention.

FIG. 5 shows a prior art base for use in a lighting fixture enclosure.

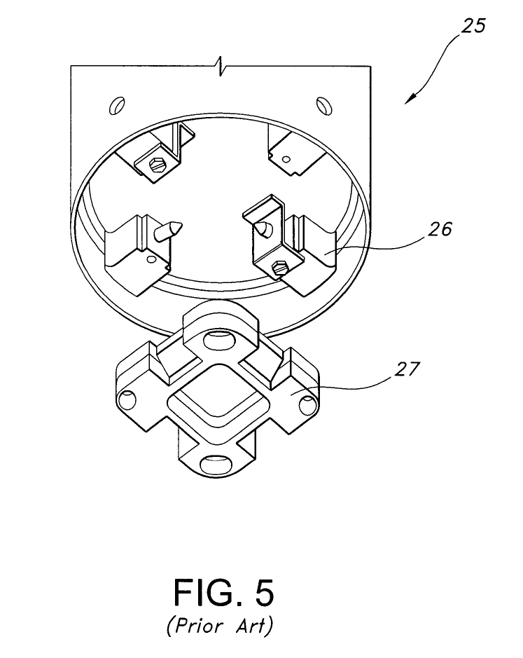

FIGS. 6A and 6B are perspective views of an embodiment of a base about which a lighting fixture enclosure is adjustable according to certain embodiments of the present invention.

### DETAILED DESCRIPTION OF THE INVENTION

The present invention provides devices and methods for externally accessing a lighting fixture optic of a ground-mounted lighting fixture enclosure to adjust the optic such that the direction of the light may be altered without complete disassembly of the top end of the lighting fixture enclosure or the use of specialized equipment. This eliminates the complexity associated with the adjustment of asymmetrical reflectors that are typically used in ground-mounted lighting fixture enclosures. In certain embodiments, the enclosure top is not removed, but rather the lighting fixture optic is accessed by removing a fastening device (e.g., a standard top screw) in the top end of the enclosure and placing a keyed tool through the hole. In this manner, fine adjustment can be made easily and checked in real time. Because the lighting fixture remains functional during the adjustment (i.e., the lamp is on), an installer may visually inspect the light distribution from the fixture from ground level after or during adjustment of the optic. This ability to check results in real time combined with being able to access the optic externally without disassembling the enclosure provides for a quick and accurate installation of the lighting fixture enclosure.

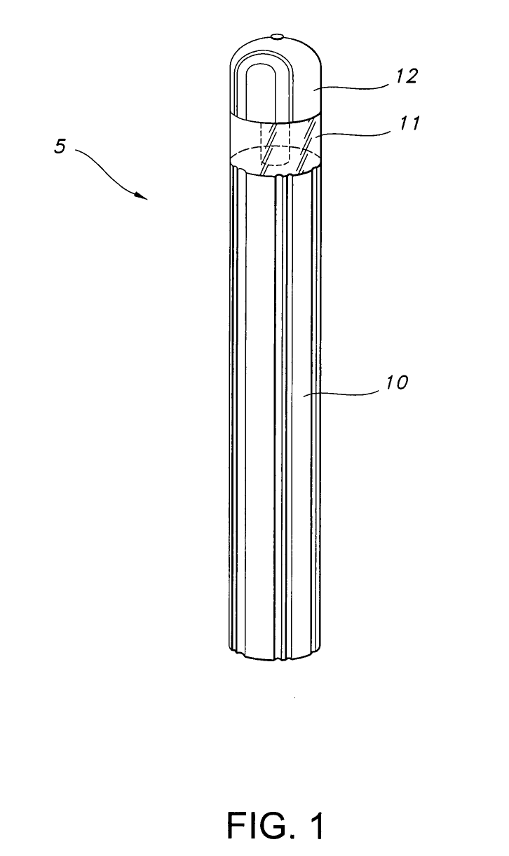

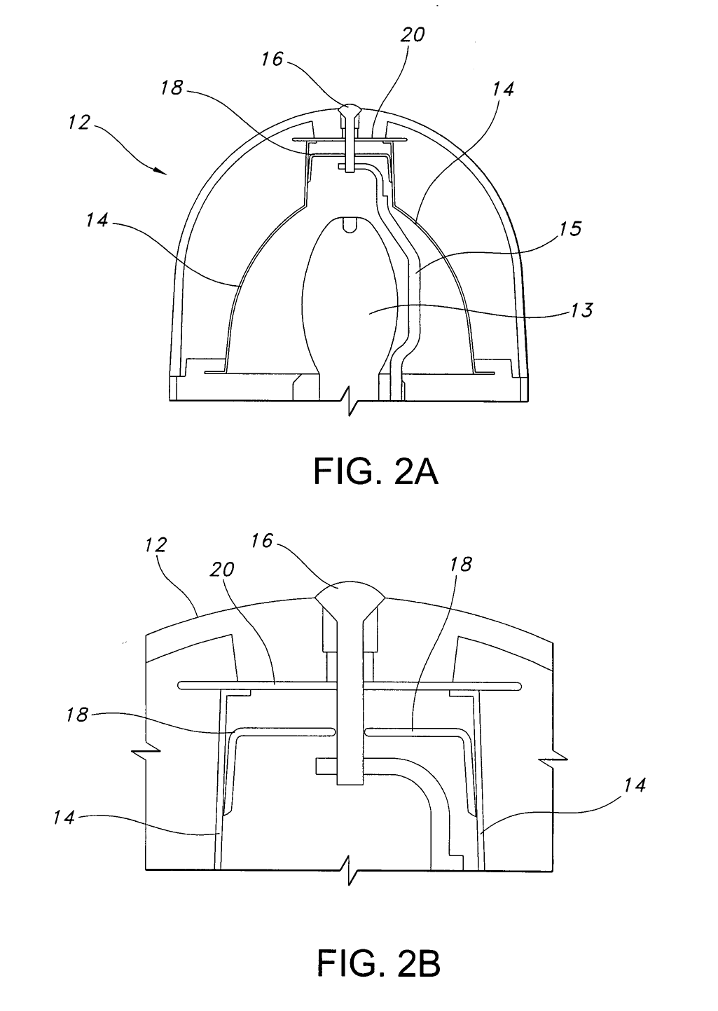

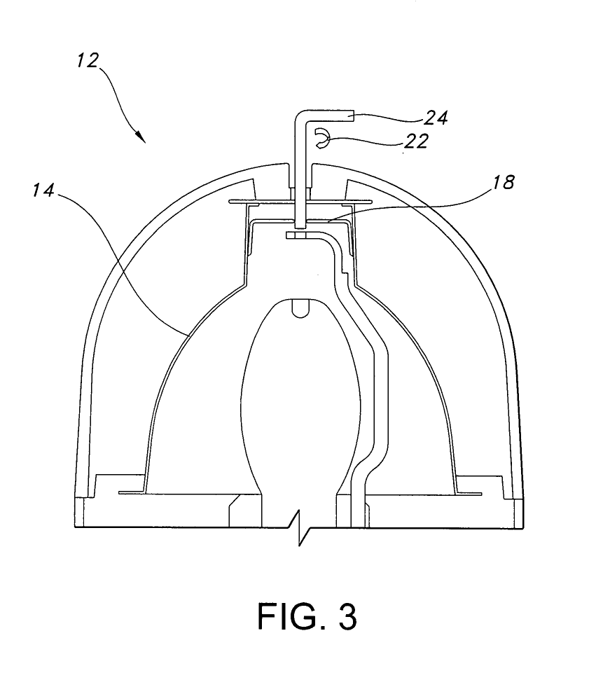

Certain exemplary embodiments of this invention may be used in any number of ground-mounted lighting fixture enclosures. For example, FIG. 1 shows a suitable lighting fixture enclosure 5 that includes a fixture top 12 mounted on a fixture body 10, and a light emitting portion 11 included as a part of the fixture top 12, the fixture body 10, or as a separate component mounted between the two. Such a device may include an externally-accessible optic such as those shown in the exemplary embodiments of FIGS. 2A, 2B, and 3.

A fixture top 12 covers the top end of the lighting fixture enclosure 5, which houses a light source 13, shown in FIG. 2A. A reflector 14 is housed inside the top end of the lighting fixture enclosure and is positioned to reflect light from the light source 13 onto the surrounding ground below via the light emitting portion 11. Fixture top 12 has a hole in its top end through which a removable fastening device can pass. For purposes of illustration and discussion, the removable fastening device is shown as a screw 16 with complimentary gasket. However, one of skill in the art will understand that any fastening device capable of temporary fixation is contemplated by this invention. The fixture top 12 also includes an interface 20 (see FIG. 2B) for suspending a reflector 14 while allowing the reflector 14 to rotate. A reflector 14 is positioned adjacent the interface 20. A bracket 18 is affixed to the reflector 14, as shown in FIG. 2A.

To assemble the fixture 5, the screw 16 is inserted through the hole in the fixture top 12, a hole in the bracket 18, and into a threaded hole in a body connector 15, which is mounted to fixture body 10 (not shown). As the screw 16 is tightened, the fixture top 12 is drawn closer to the body connector 15 (and thus the fixture body 10). A gasket may be provided in the hole in fixture top 12 to seal the hole and ensure that the screw 16 remains seated therein.

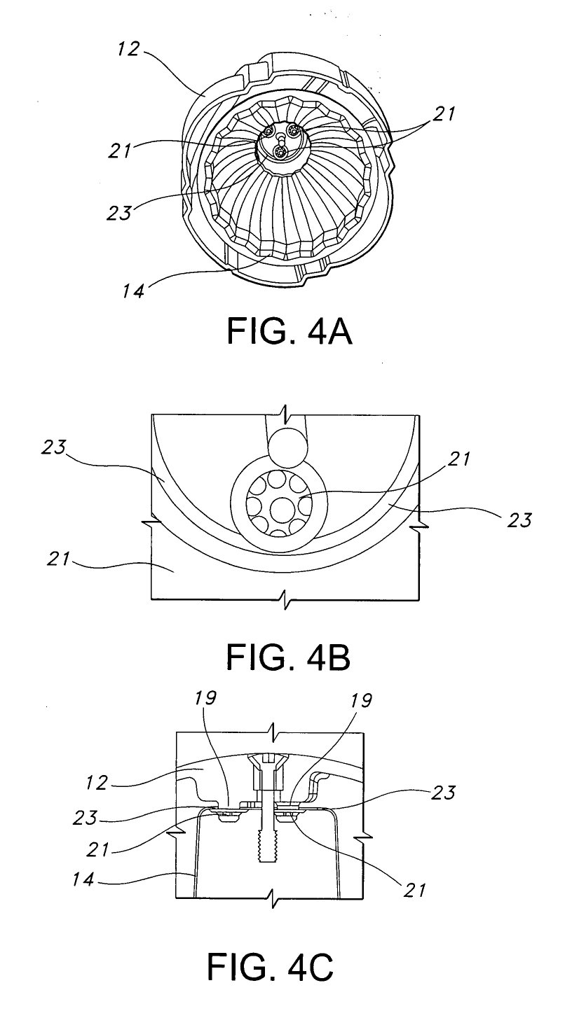

In certain embodiments, the reflector 14 is movably coupled to an inside surface of the fixture top 12, as shown in FIGS. 4A, 4B, 4C. The fixture top 12 includes three posts 19 (partially shown), each of which has a washer 21 at its end. When the reflector 14 is installed in the fixture top 12, the three posts 19 extend in a generally downward direction to contact or nearly contact the lip 23 of the reflector 14 in different areas around the internal circumference of the lip 23. The washers 21, which are preferably internal tooth lock washers, are screwed onto the end of each of the posts 19 where each washer engages a different portion along the bottom of the lip 23 of the reflector 14. With the washers 21 so engaging the lip 23, the reflector 14 is suspended inside the fixture top 12.

The interactions between the posts 19, washers 21, and lip 23 of the reflector 14 allow the reflector 14 to be suspended within the fixture top 12 with limited ability to shift or wobble, while being free to rotate about its axis. As the reflector 14 is rotated with respect to this axes and thus with respect to the posts 19 of fixture top 12, the reflector's lip 23 is free to rotate while supported in its suspended position with respect to the fixture top 12 by the washers 21. This is because the friction created by the contact between the washers 21 and the lip 23 is not sufficient to prevent rotation. In addition, the spatial relationship between the posts 19 and/or washers 21 and the lip 23 of the reflector also limits the amount the reflector is able to shift or wobble from side to side. One of skill in the art will understand that other mechanical retention devices may be used to suspend the reflector 14 within the fixture top 12.

External access to the reflectors rotational orientation is facilitated in certain embodiments through the use of a bracket. The bracket 18, shown in FIGS. 2A, 2B, and 3, is secured to reflector 14 such that the opening in the bracket 18 is coaxial with the reflector's central axis. The opening or aperture in the bracket 18 is configured to allow passage of the screw 16 without engaging it while allowing, when the screw 16 is removed, a tool 24 to engage and rotate the bracket 18. For example, the opening in the bracket 18 may have a hexagonal cross-sectional shape to interact with a tool 24 having a hexagonal cross section (e.g., an Allen wrench). Such an opening may allow passage and free rotation of a screw 16 having a generally round but smaller cross section, without the insertion, removal, or rotation of the screw 16 impacting the bracket 18 (and thus the reflector 14) rotational orientation.

When the rotational orientation of reflector 14 requires adjustment, screw 16 is removed from fixture top 12, but fixture top 12 is left in place at the top end of the lighting fixture enclosure 5. A tool, such as the tool 24 shown in FIG. 3, is inserted through the hole in fixture top 12 vacated by screw 16 and into engagement with bracket 18. As explained above, the hole in bracket 18 is shaped to correspond to the cross-sectional shape of tool 24. Reflector 14 is then rotated along axis of rotation 22, shown in FIG. 3, by moving tool 24 as desired. Once reflector 14 is in the desired position, tool 24 is removed and screw 16 is inserted to again secure fixture top 12 at the top end of the lighting fixture enclosure 5.

The invention also provides devices and methods for externally rotating a ground-mounted lighting fixture enclosure such that lighting fixture enclosures may be aesthetically and optically aligned with one another and to the surrounding architecture. This allows the rotation of the lighting fixture to be adjusted. Certain embodiments, although not all, allow the fixture to be rotated a full 360 degrees in any direction before final tightening. A base providing the ability for the lighting fixture enclosure to be adjusted or rotated eliminates the need to precisely measure, square, and set in concrete (or other substrate) the anchor bolts, which is otherwise necessary in existing systems where the lighting fixture enclosures are intended to be aligned with respect to each other and surrounding architecture. Certain embodiments also provide the ability for precise real time adjustment of the lighting fixture enclosure with respect to other enclosures and the surrounding architecture. In certain embodiments, the base can accommodate any anchor bolt orientation and may be used with lighting fixture enclosures of any of a number of shapes.

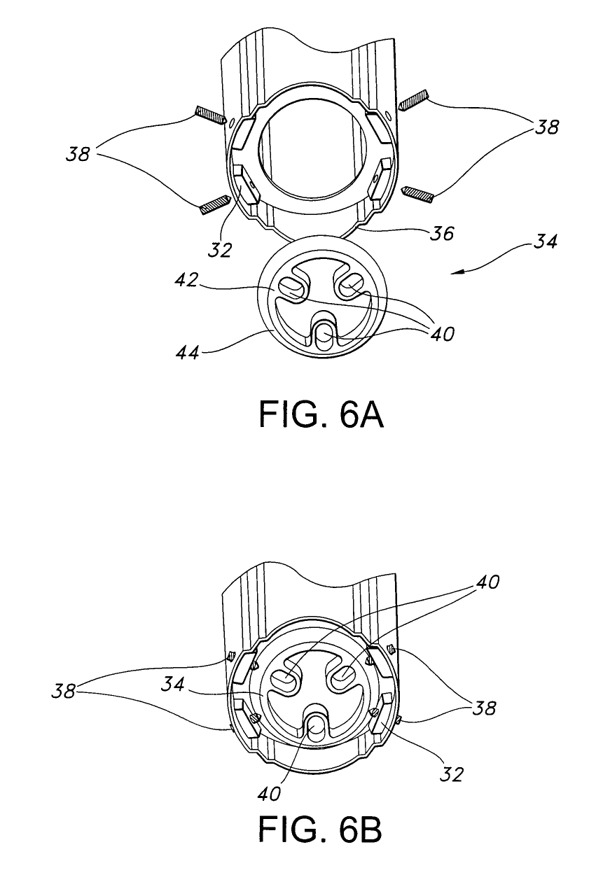

Certain exemplary embodiments of this invention may be used in any number of ground-mounted lighting fixture enclosures. For example, a suitable lighting fixture enclosure is shown in FIG. 1. FIG. 6A shows an exemplary embodiment of an adjustable base system according to the present invention. The base 34 generally includes frame 42 and at least one flange 44 that extends outwardly from the frame. In the illustrated embodiment, the frame is circular-shaped and includes mounting apertures 40. The frame need not be circular shaped but rather may be any shape. Moreover, while three mounting apertures 40 are shown, any number may be used. The illustrated flange 44 is substantially circular-shaped, which, as explained below, enables the lighting fixture enclosure 5 to be rotated through 360 degrees relative to the base 34. Other embodiments may use any suitable shape that allows partial (e.g., less than 360 degrees) or complete (e.g., 360 degrees) rotational freedom.

A base support 32 is provided on the inside of the bottom end 36 of lighting fixture enclosure 5. Base support 32 may be affixed to enclosure 5 using any mechanical retention means, all of which are well understood by those skilled in the art, or may be integrally formed with the enclosure 5. Base support 32 is shaped to receive base 34 and in particular flange 44 of the base 34.

To install enclosure 5 in the ground, the base 34 is mounted to the desired ground surface by inserting anchor bolts or other securing devices (not shown) into mounting apertures in the base 34. Then, bottom end 36 of the enclosure 5 is placed over base 34 so that flange 44 of base 34 is seated in base support 32. Set screws 38 are then tightened, clamping base 34 to base support 32 of enclosure 5.

Tightening one or more of the set screws 38 prevents any further rotation of enclosure 36 about base 34. For example, the set screws 38 may each be made of a relatively hard material such as steel and have a cone point that, when tightened, bears against, digs into and/or deforms the frame 42 of base 34, which may be made of a softer material such as cast aluminum. If rotational adjustment is later desired, the set screws 38 may simply be loosened, enclosure 5 adjusted by rotating the entire enclosure (including the base support 32 about the base 34 (which is fixed relative to the ground), and the set screws 38 tightened once again.

That the frame 42 of the base 34 with which the set screws 38 interact is circular ensures that the provided set screws 38 will always be able to interact with the frame 42 of the base 34 and thereby fix the orientation of the enclosure 5, regardless of that orientation. Other embodiments can utilize bases of other shapes and characteristics that permit partial or complete rotation of the enclosure 5 around a base. For example, portions of the base 34 may form arcs that allow a limited range of rotation. Moreover, while in the illustrated embodiment four set screws 38 are used to clamp base 34 to base support 32, any number of set screws may be used or other mechanisms for securely engaging base 34 to base support 32 or to enclosure 5 may be used, as is well understood by those skilled in the art. However, it is preferable, but certainly not required, that at least one pair of opposing set screws 38 be used.

The components used to implement devices according to the inventions described herein may be made of any suitable materials as will be apparent to those of ordinary skill in the art given the particular context and application. The reflector will typically be made of aluminum, but may also be made of steel, other metals, composite polymers, or any other suitable materials. The fixture enclosure, including the top and body, will typically be made of aluminum, but may also be made of steel, other metals, concrete, wood, composites, or any other suitable material. The base support and base will typically be made of a relatively stronger material such as steel or aluminum, but any suitable material may be used. Moreover, one of skill in the art will recognize that certain of the components disclosed herein need not be provided as separate components but rather may be integrally formed with other of the disclosed components. By way only of example, bracket 18 may be integrally-formed with reflector 14, base support 32 may be integrally formed with enclosure 5, etc.

The foregoing description of the exemplary embodiments of the invention has been presented only for the purposes of illustration and description and is not intended to be exhaustive or to limit the invention to the precise forms disclosed. Many modifications and variations are possible. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art without departing from its spirit and scope.

What is claimed is:

1. A lighting system comprising a lighting fixture enclosure comprising:
a body;
a fixture top coupled to the body to form the enclosure within which a light source is mounted, wherein the fixture top comprises an opening that receives a fastening device;
a reflector positioned inside the fixture top and having a rotational orientation;
wherein the reflector rotational orientation is externally adjustable.

2. The lighting system of claim 1, wherein the reflector rotational orientation is externally adjustable through the opening in the fixture top.

3. The lighting system of claim 2, further comprising a tool, wherein the reflector rotational orientation is externally adjustable by inserting the tool through the opening.

4. The lighting system of claim 1, further comprising a bracket provided on the reflector and having an aperture that is substantially coaxial with the opening.

5. The lighting system of claim 4, further comprising a tool adapted to be inserted through the opening, engage the bracket aperture, and rotate the bracket to adjust the rotational orientation of the reflector.

6. A method of adjusting a lighting fixture comprising:
providing a lighting fixture comprising (a) a body, (b) a fixture top coupled to the body to form an enclosure within which a light source is mounted, wherein the fixture top comprises an opening that receives a fastening device, and (c) a reflector positioned inside the fixture top and having a rotational orientation;
inserting a tool through the opening in the fixture top; and
rotating the tool to change the rotational orientation of the reflector.

7. The method of claim 6, wherein providing a lighting fixture provides a lighting fixture that further comprises a bracket provided on the reflector and having an aperture that is substantially coaxial with the opening.

8. The method of claim 7, further comprising:
engaging the bracket aperture with the inserted tool, and
rotating the tool to rotate the bracket and change the rotational orientation of the reflector.

9. A lighting system comprising:
a lighting fixture enclosure having a base support located therein; and
a base mountable to an underlying surface and shaped to engage the base support of the lighting fixture enclosure such that the lighting fixture enclosure is rotatable about the base.

10. The system of claim 9, further comprising a plurality of set screws for securing the base to the base support.

11. The system of claim 9, wherein the base support is welded inside the bottom end of the lighting fixture enclosure.

12. The system of claim 9, wherein the base has a shape that is substantially circular.

13. The system of claim 9, wherein the lighting fixture enclosure is rotatable three-hundred sixty degrees about the base.

14. The system of claim 9, further comprising anchor bolts that are received within openings in the base for mounting the base to the surface.

15. A method of installing a surface-mounted lighting fixture comprising:
providing a base for mounting to a surface;
securing the base to a surface;
positioning a light over the base;
rotating the light relative to the base; and
securing the light to the base.

16. The method of claim 15, wherein the light comprises a light source within a lighting fixture enclosure having a base support.

17. The method of claim 16, wherein positioned the light over the base comprises engaging the base support of the lighting fixture enclosure such that the lighting fixture enclosure is rotatable about the base.

18. The method of claim 17, wherein securing the light to the base comprises tightening a plurality of set screws from the base support into a substantially circular frame of the base.
